(19) United States
(12) Patent Application Publication
(10) Pub. No.: US 2016/0129458 A1
(43) Pub. Date: May 12, 2016

(54) CLEANING NOZZLE WITH EDDY CURRENT BRAKE SYSTEM

(71) Applicant: Enz Technik AG, Giswil (CH)

(72) Inventor: Christoph LENDI, Giswil (CH)

(73) Assignee: ENZ TECHNIK AG, Giswil (CH)

(21) Appl. No.: 14/567,379

(22) Filed: Dec. 11, 2014

(30) Foreign Application Priority Data
Nov. 11, 2014 (CH) 01746/14

(51) Int. Cl. B05B 3/00; B05B 3/06; F16F 15/18; B08B 9/032

(52) U.S. Cl. CPC B05B 3/006; B08B 9/0321; B05B 3/06; F16F 15/18

(57) ABSTRACT

The invention aims to achieve extended service lives in a multipart cleaning nozzle (1) comprising a stator part (2), on which a rotor part (3) can be supported and fixed stationarily, but rotatably about a longitudinal axis (L), by means of a head (4), wherein a brake system comprises a brake drum (20) on the stator part (2) and a plurality of permanent magnets fixed in magnet pockets (301) on the rotor part (3), and wherein the rotational speed of the rotor part (3) due to the effect of the pressure and recoil of a jet ejected from at least one outlet nozzle (310) arranged on the rotor part (3) can be reduced due to an interaction between the brake drum (20) and the plurality of permanent magnets. This is achieved in that the magnet pockets (301) are realized with round cross-sectional areas and arranged in a circumferential surface of a diminished section (30) in two or more circumferential rows such that they are spaced apart from one another in the direction of the longitudinal axis (L), wherein the permanent magnets respectively have round cross-sectional areas and are inserted and fixed in the magnet pockets (301) separately in the direction of the longitudinal axis (L).

### TECHNICAL FIELD

The present invention pertains to a multipart cleaning nozzle for cleaning pipes and channels with a fluid, comprising a stator part, on which a rotor part can be supported and fixed stationarily, but rotatably about a longitudinal axis, by means of a head, wherein a brake system comprises a brake drum on the stator part and a plurality of permanent magnets fixed in magnet pockets on the rotor part, and wherein the rotational speed of the rotor part can be reduced under the effect of the pressure and recoil of a jet ejected from at least one outlet nozzle arranged on the rotor part due to an interaction between the brake drum and the plurality of permanent magnets, as well as to a brake system of a cleaning nozzle for cleaning pipes and channels with a fluid, wherein the brake system comprises a brake drum that is arranged on a stator part stationarily and in a rotationally fixed fashion, as well as a plurality of permanent magnets fixed in magnet pockets on a rotor part.

### BACKGROUND

Cleaning nozzles have been used for cleaning pipes with a fluid, usually water, under high pressures for quite some time.

Such cleaning nozzles are usually divided into two parts and consist of a stator part and a rotor part that is rotatably supported on the stator part. The fluid is conveyed through the stator part and the rotor part and can be ejected from an outlet opening of a nozzle on the rotor part in the form of a jet. The recoil of the jet makes it possible to achieve a high-speed rotation of the rotor part about a longitudinal axis of the cleaning nozzle.

The fluid pumps used operate with 30 liters to 50 liters of water per minute at pressures up to 2.5 kbar (250 Mpa). Due to the high pressure, non-decelerated cleaning nozzles rotate with tens of thousands of revolutions per minute. The jet ejected at these speeds atomizes at a distance of approximately 1 mm to 2 mm from the outlet opening of the nozzle on the rotor part depending on the rotational speed. Due to the high rotational speed, the jet already loses its cleaning effect a short distance from the cleaning nozzle. At such high rotational speeds, the material used for the cleaning nozzles is also subjected to extreme wear such that the service life of the cleaning nozzles is reduced. It was attempted to find solutions for achieving a sound braking effect with reduced wear.

Cleaning nozzles that utilize eddy currents induced by permanent magnets for respectively reducing the rotational speed of the cleaning nozzles or of the rotor part of the cleaning nozzles were already disclosed in the DE3812132. The braking effect could be adjusted by adjusting the distances between the permanent magnets and a copper ring. Elongated permanent magnets were used and arranged at the shortest possible distance from the copper ring in order to achieve maximum penetration of the magnetic field and therefore the maximum braking effect. Although the braking effect is realized in a contactless fashion without mechanical friction in this case, the adjustment options of the braking effect and the attainable lengths of the ejected jets were still unconvincing.

CH699422 of the applicant disclosed an optimized cleaning nozzle with decelerated rotor part that had a stronger braking effect such that greater lengths of the ejected jets could be achieved and the cleaning efficiency could thusly be increased.

According to the exploded view illustrated in FIG. 1, the cleaning nozzle 1 is composed of a stator part 2, a rotor part 3 and a head 4. A brake system is provided in order to reduce the rotational speed, wherein this brake system comprises a plurality of permanent magnets 300 that are fixed in magnet pockets 301 on the rotor part.

The rod-shaped permanent magnets 300 are fixed in magnet pockets 301 that are recessed into the cylindrical outer surface of a diminished section of the rotor part 3 such that they are uniformly distributed along the circumference. In this case, the magnet pockets 301 and the rod-shaped permanent magnets 300 are arranged in n=6 longitudinal rows parallel to the longitudinal axis. In the operating state, the diminished section of the rotor part 3 and therefore the permanent magnets 300 are surrounded by a brake drum 20 of the stator part 2.

The braking effect is based on voltages that are induced in the brake drum 20 due to the rotating permanent magnets 300 and associated rotating permanent magnetic fields and generate eddy currents in the brake drum 20. According to Lentz's law, these eddy currents result in eddy current magnetic fields that enclose the brake drum 20 and are directed opposite to their cause. Consequently, the induced eddy current magnetic fields are respectively directed opposite to the permanent magnetic field of the rotating permanent magnets 300 such that the rotational motion of the rotor part 3 is decelerated.

A cleaning nozzle 1 of this type is characterized by the lack of mechanical wear of the components of the rotor part 3 during the deceleration. A minimal gap between the outwardly directed surface of the permanent magnets 300 and the inner surface of the brake drum 20 can be achieved by using the plurality of rod-shaped permanent magnets 30. Consequently, a maximum braking effect can be achieved by using the thinnest rod-shaped permanent magnets 300 possible. Due to the homogenous distribution of the permanent magnets 300 over the circumference of the diminished rotor part 3 in the form of the six longitudinal rows shown, the cleaning nozzles 1 can be operated with water pressures up to 2.5 kbar. The attained braking properties lead to an enormous increase in the length of the ejected jets to several 10 mm. Accordingly, it is possible to clean pipes with varying pipe diameters, namely also pipes with pipe diameters that deviate from the diameter of the cleaning nozzle 1 by several 10 mm. Due to the braking effect, the ejected jet still has sufficient energy for cleaning the pipe wall.

The service life of the cleaning nozzle 1 is significantly extended due to the reduction of the rotational speed. In practical applications, however, the previous maximum permissible pressure of 2.5 kbar is frequently exceeded by the user of the cleaning nozzle 1. This is no problem with currently used pumps. Since increased fluid pressure leads to ejected jets with higher energy and therefore greater cleaning power, it is sometimes attempted to operate above 2.5 kbar because the cleaning personnel is under enormous time pressure and therefore wants to complete the cleaning process as quickly as possible. However, extremely high centrifugal forces act upon the permanent magnets 300 at such high fluid pressures. Until now, it frequently occurred in practical applications that the braking effect already diminished after a short period of time, sometimes within the first hour of operation, and the permanent magnets 300 then partially separated from the rotor part 3. Loose permanent magnets 300 lead to mechanical contact with the brake drum 24 such that the cleaning nozzle is rendered unusable and needs to be replaced. This problem could neither be solved by utilizing stronger permanent magnets 300 with increased magnetic flux density, increasing the number of longitudinal rows of permanent magnets 300 nor additionally reducing the gap between the brake drum 20 and the surface of the permanent magnet 300 or of the diminished section of the rotor part 3, respectively.

Since it was already known from DE3812132 that the gap between the permanent magnets 300 and the brake drum 20 needs to be a small as possible, narrower rod-shaped permanent magnets were used and arranged in corresponding additional longitudinal rows. Aside from a more elaborate manufacture, this did not make it possible to fix the permanent magnets in a more stable fashion. Even the use of permanent magnets with an outwardly rounded outer surface facing the brake drum 20 was unsuccessful. Although the distance between the brake drum 20 and the rounded outer surface of the permanent magnets could be additionally reduced in this case, the resulting service life could not be extended.

### DISCLOSURE OF THE INVENTION

The present invention is based on the objective of developing a cleaning nozzle with sufficient length of the ejected jet and with a more robust rotor part that is decelerated in a contactless fashion and even shows hardly any wear phenomena when fluid pressures up to 3 kbar are used such that the service lives are significantly extended.

This objective is attained by adapting the brake system such that permanent magnets with round cross section are used and arranged on the rotor part in several rows along the circumference. Contrary to the experience of a person skilled in the pertinent art, permanent magnets with round cross section were used and inevitably resulted in an increased gap between the inner surface of the brake drum and the circumferential surface of the rotor part or the outer surfaces of the permanent magnets, respectively. Astonishingly, the deterioration of the braking effect caused by the increased distance could be more than compensated with the arrangement of several circumferential rows of permanent magnets in the circumferential direction.

Even the manufacture of the inventive cleaning nozzles has been simplified because the arrangement of magnet pockets with round cross section is easier than the machining of longitudinal grooves.

Separation of the permanent magnets is prevented even when fluid pressures of 3 kbar are used such that a contactless braking effect is maintained over a longer period of time.

### BRIEF DESCRIPTION OF THE DRAWINGS

Other characteristics, details and advantages of the invention can be gathered from the following description of preferred embodiments of the invention, as well as the drawings.

FIG. 1 shows an exploded view of a cleaning nozzle according to the prior art with eddy current brake.

FIG. 2 shows an exploded view of an inventive cleaning nozzle with modified brake system.

FIG. 3a shows a side view of a rotor part, wherein a diminished section featuring magnet pockets with round cross-sectional area arranged in two circumferential rows is inserted into a brake drum.

FIG. 3b shows a schematic view in the direction of the longitudinal axis of the rotor part of an inventive cleaning nozzle with four round permanent magnets arranged in a first circumferential row.

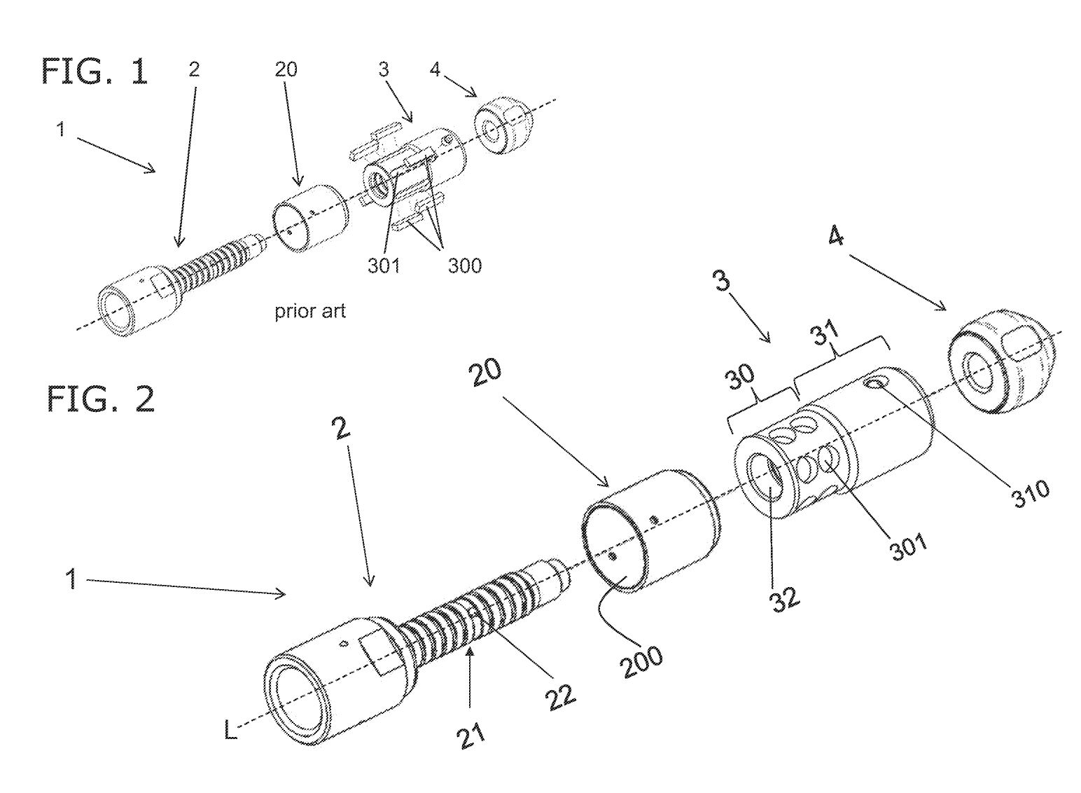

### DESCRIPTION

The inventive multipart cleaning nozzle 1 comprises a stator part 2, on which a rotor part 3 can be fixed stationarily, but rotatably about a longitudinal axis L, wherein a head 4 can also be fixed on said stator part. In this case, the head 4 merely serves for stationarily fixing the rotor part 3.

Such a cleaning nozzle 1 is based on cleaning nozzles of the type already disclosed in CH699422 of the applicant and used for cleaning pipes and channels with water under high pressures up to 3 kbar.

The stator part 2 features a coupling and a connected cylindrical shaft 21. A water line is connected to the stator part 2 by means of the coupling in order to operate the cleaning nozzle. A supply line longitudinally extends within the stator part 2 from the coupling into the shaft 21 and across the shaft 21. A brake drum 20 of an electrically conductive material is arranged such that it at least partially overlaps the shaft 21 and fixed on the stator part 2. A labyrinth seal and an annular groove are usually arranged on the surface of the shaft 21, wherein an outlet bore 22 is produced within the annular groove. From the supply line, the cleaning medium that usually consists of water can escape from the shaft 21 through the outlet bore 22. A thread is arranged on the side of the shaft 21 that lies opposite of the coupling side in order to attach the head 4.

In the assembled state, the rotor part 3 is fixed on the shaft 21 such that it is rotatable about the longitudinal axis L and at least partially protrudes into the brake drum 20. Along its longitudinal extent, the rotor part 3 comprises a diminished section 30 and a nozzle section 31, wherein the nozzle section 31 faces the head 4 in the mounted state in this case. An outlet nozzle 310 positioned at the end of an outlet channel is arranged in the nozzle section 31. The rotor part 3 features a central through-opening 32 that can be partially acted upon with water and through which the shaft 21 of the stator part 2 can be guided in a completely crossing fashion. The central through-opening 32 leads into the outlet channel.

The head 4 features fixing means, particularly a screw thread, such that the head 4 can be screwed onto the end of the shaft 21 protruding through the rotor part 3 after the installation of the rotor part 3 on the shaft 21. The head 4 is screwed onto the end of the shaft 21 that lies on the remote side of the stator part 2 referred to the coupling.

The brake system is formed by a brake drum 20 of the stator part 2 and by a plurality of permanent magnets (not illustrated in FIG. 2) that are bonded into a plurality of magnet pockets 301 within the diminished section 30.

In the assembled state of the cleaning nozzle 1, the brake drum 20 is fixed on the stator part 2, wherein the shaft 21 extends across the brake drum 20 in the longitudinal direction L and partially protrudes from the brake drum 20. The rotor part 3 is attached such that it receives the shaft 21 in the through-bore 32, wherein the diminished section 30 with the permanent magnets is within the brake drum 20 positioned above the shaft 21 and the nozzle section 31 extends across the shaft 21 at a distance from the brake drum 20.

After fixing the rotor part 3 on the shaft 21 by means of the head 4, the cleaning nozzle 1 can be acted upon with water. The head 4 may be positively and/or non-positively fixed on the shaft 21, for example, by means of a screw connection.

During the operation, water longitudinally flows through the supply line within the shaft 21 under high pressure until it reaches the outlet bore 22, where it exits the shaft 21. In the assembled state of the cleaning nozzle 1, the outlet bore 22 lies at the height of the outlet nozzle 310 in the nozzle section 31. The water passing through the outlet nozzle 310 generates recoil that exerts a torque upon the rotor part 3 such that it rotates.

If the rotation of the rotor part 3 is not decelerated, the fluid jet being ejected from the outlet nozzle 310 is atomized in such a way that it hardly has any cleaning effect when it impacts on a pipe wall.

Accordingly, it is absolutely imperative to provide a brake system for reducing the rotational speed of the rotor part 3.

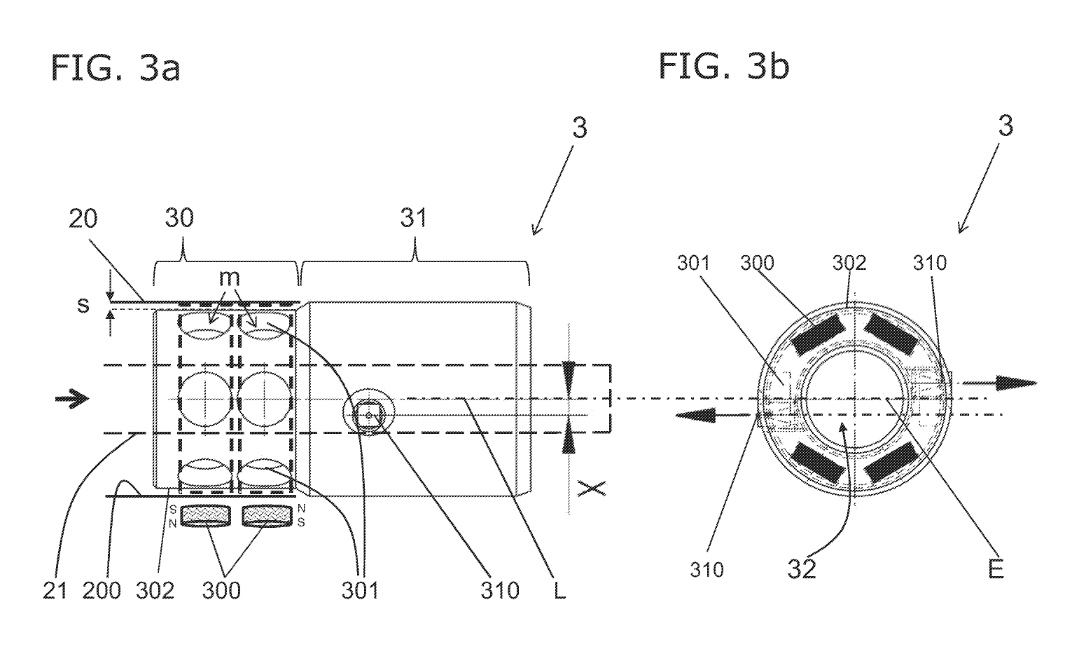

The characteristics of the brake system are described in greater detail below with reference to FIGS. 3a and 3b.

The diminished section 30 of the rotor part 3 is realized in such a way that a circumferential surface 302 of the diminished section 30 is in the assembled cleaning nozzle 1 spaced apart from an inner surface 200 of the brake drum 20 by a minimal distance s. The magnet pockets 301 are separately arranged at a distance from one another in the circumferential surface 302. The magnet pockets 301 are realized in the form of blind holes that have a round cross-sectional area. The magnet pockets 301 are arranged at different distances in two or more separate circumferential rows extending along the circumference of the diminished section 30 and oriented in the direction of the longitudinal axis L. Along the circumference, each circumferential row m respectively comprises six magnet pockets 301 in this case. The figures show two exemplary permanent magnets 300 that have a round cross-sectional areas and a size that is adapted to the diameter of the magnet pockets 301. In the drawings shown, the permanent magnets 300 were largely omitted in order to better illustrate the magnet pockets 301.

Depending on the desired braking effect, either all magnet pockets 301 of all circumferential rows m are fitted with permanent magnets 300 or a few magnet pockets 301 remain unoccupied. The permanent magnets 300 respectively are inseparably fixed in the magnet pockets 301 in a firmly bonded fashion. Plane permanent magnets 300 with radially oriented north poles N and south poles S are used. The magnetizing direction of adjacent circumferential rows m may be aligned differently or identically, wherein a braking effect develops in any case due to Lenz's law.

The magnet pockets 301 are realized in the form of blind holes with such a depth that the surface of the permanent magnets 300 facing away from the longitudinal axis L only protrudes slightly from the circumferential surface 302, if at all. The depth of the blind holes is limited because a sufficiently thick wall needs to remain between the blind holes and the through-bore 32 for stability reasons. The permanent magnets 300 are sufficiently fixed by being embedded in an adhesive within the magnet pockets 301.

Tests with m=2 and m=3 circumferential rows have shown sound braking effects although the gap s between the circumferential surface 302 and the inner surface 200 of the brake drum 20 is greater than in the prior art. Although the magnetic forces of the permanent magnets 300 with round cross-sectional area rather act upon the circumferential surface 302 of the diminished section 30 in a punctiform fashion, a desired braking effect could be achieved by using a number m of circumferential rows greater than or equal to 2.

According to FIG. 3b, two outlet channels leading into two outlet nozzles 310 are recessed into the diminished section 30. In order to generate a torque due to the recoil, the outlet nozzles 310 are arranged with an offset x referred to a central longitudinal plane E. This offset x is realized as small as possible in order to achieve a sufficient torque of the rotor part 3, wherein the rotor part 3 can be decelerated by means of the brake system. A cleaning nozzle 1 with sufficiently decelerated rotor part 3 could be realized with an offset x from the central longitudinal plane E between 0.1 and 0.3 mm.

Due to the arrangement of several permanent magnets 300 with round cross-sectional area in two or more circumferential rows m, washing water flowing within the cleaning nozzle 1 and rebound water cannot separate the bonded permanent magnets 300 from the individual magnet pockets 301 such that significantly longer service lives can be achieved. Washing water flows around the plurality of permanent magnets without separating effect. Depending on the fitting of the magnet pockets 301, the attained braking properties lead to desired lengths of the ejected jet of up to 100 mm, as well as extended service lives.

### REFERENCE LIST

1 Cleaning nozzle

2 Stator part
20 Brake drum
   200 Inner surface
21 Shaft
22 Outlet bore

3 Rotor part
30 Diminished section of rotor part (cylindrical)
   300 Permanent magnet
   301 Magnet pockets
   302 Circumferential surface of diminished section
   m Circumferential row (m>=0)
   N Magnetic north pole
   S Magnetic south pole
31 Nozzle section of rotor part
   310 Outlet nozzle
32 Through-bore

4 Head

x Offset

s Gap between circumferential surface and inner surface

L Longitudinal axis

E Central longitudinal plane

1. A multipart cleaning nozzle for cleaning pipes and channels with a fluid, comprising a stator part, on which a rotor part can be supported and fixed stationarily, but rotatably about a longitudinal axis, by means of a head, wherein a brake system comprises a brake drum on the stator part and a plurality of permanent magnets fixed in magnet pockets on the rotor part, and wherein the rotational speed of the rotor part due to the effect of the pressure and recoil of a jet ejected from at least one outlet nozzle arranged on the rotor part can be reduced due to an interaction between the brake drum and the plurality of permanent magnets,
wherein
the magnet pockets are realized with round cross-sectional areas and arranged in a circumferential surface of a diminished section in two or more circumferential rows such that they are spaced apart from one another in the direction of the longitudinal axis, wherein the permanent magnets respectively have round cross-sectional areas and are inserted and fixed in the magnet pockets separately in the direction of the longitudinal axis.

2. The multipart cleaning nozzle according to claim 1, wherein at least two outlet nozzles are arranged in a nozzle section of the rotor part such that they communicate with a through-bore extending through the rotor part.

3. The multipart cleaning nozzle according to claim 2, wherein the outlet nozzles are arranged with an offset from a central longitudinal plane of the rotor part between 0.1 and 0.3 mm.

4. The multipart cleaning nozzle according to claim 1, wherein the permanent magnets are fixed in the magnet pockets inseparably and in a firmly bonded fashion by means of adhesive connections.

5. The multipart cleaning nozzle according to claim 1, wherein the two or more circumferential rows of magnet pockets and permanent magnets are arranged in such a way that they are completely surrounded by an inner surface of the brake drum with a gap.

6. The multipart cleaning nozzle according to claim 1, wherein the magnetic polarization of the permanent magnets of adjacent circumferential rows is respectively aligned in opposite directions.

7. A brake system of a cleaning nozzle for cleaning pipes and channels with a fluid, wherein the brake system comprises a brake drum that is arranged on a stator part stationarily and in a rotationally fixed fashion, as well as
a plurality of permanent magnets fixed in magnet pockets on a rotor part,
wherein
the magnet pockets are realized with round cross-sectional areas and arranged in a circumferential surface of a diminished section in two or more circumferential rows such that they are spaced apart from one another in the direction of the longitudinal axis, wherein the permanent magnets respectively have round cross-sectional areas and are inserted and fixed in a firmly bonded fashion in the magnet pockets separately in the direction of the longitudinal axis.
